(19) United States
(12) Patent Application Publication
(10) Pub. No.: US 2023/0206157 A1
(43) Pub. Date: Jun. 29, 2023

(54) PERFORMANCE MANAGEMENT

(71) Applicant: Nabors Drilling Technologies USA, Inc., Houston, TX (US)

(72) Inventors: Scott Boone, Houston, TX (US); Pradeep Annaiyappa, Houston, TX (US)

(21) Appl. No.: 18/059,600

(22) Filed: Nov. 29, 2022

Related U.S. Application Data
(60) Provisional application No. 63/266,156, filed on Dec. 29, 2021.

(51) Int. Cl. G06Q 10/0639

(52) U.S. Cl. CPC G06Q 10/06393

(57) ABSTRACT

A method for performing a subterranean operation that can include operations for controlling, via an individual driller, execution of at least a portion of a digital rig plan that is an implementation of a digital well plan on a rig; determining, via a rig controller, a first performance score of the individual driller for controlling the execution of the portion; and adjusting, via the rig controller, a second performance score of the digital rig plan based on the first performance score of the individual driller, where the second performance score indicates performance of the digital rig plan to the digital well plan.

### CROSS-REFERENCE TO RELATED APPLICATION(S)

This application claims priority under 35 U.S.C. § 119(e) to U.S. Provisional Application No. 63/266,156, entitled “PERFORMANCE MANAGEMENT,” by Scott BOONE et al., filed Dec. 29, 2021, which is assigned to the current assignee hereof and incorporated herein by reference in its entirety.

### FIELD OF THE DISCLOSURE

The present invention relates, in general, to the field of drilling and processing of wells. More particularly, present embodiments relate to a system and method for detecting and managing performance indices of a rig and its personnel for a subterranean operation, such as drilling and processing of a well.

### BACKGROUND

During well construction operations, activities on a rig can be organized according to a well plan. The well plan can be converted to a rig plan (i.e., rig specific well construction plan) for implementation on a specific rig. Deviations from the well plan or rig plan can cause rig delays, increase well site operation costs, and cause other impacts to operations. Delays in identifying the deviations can exacerbate these impacts. Therefore, improvements in rig performance monitoring and reporting are continually needed.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by the data processing apparatus, cause the apparatus to perform the actions. One general aspect includes a method for performing a subterranean operation. The method can include controlling, via an individual driller, execution of at least a portion of a digital rig plan, where the digital rig plan is an implementation of a digital well plan on a rig; determining, via a rig controller, a first performance score of the individual driller for controlling the execution of the portion; and adjusting, via the rig controller, a second performance score of the digital rig plan based on the first performance score of the individual driller, where the second performance score indicates the performance of the digital rig plan to the digital well plan. Other embodiments of this aspect include corresponding computer systems, apparatus, and computer programs recorded on one or more computer storage devices, each configured to perform the actions of the methods.

### BRIEF DESCRIPTION OF THE DRAWINGS

These and other features, aspects, and advantages of present embodiments will become better understood when the following detailed description is read with reference to the accompanying drawings in which like characters represent like parts throughout the drawings, wherein:

FIG. 1A is a representative simplified front view of a rig being utilized for a subterranean operation, in accordance with certain embodiments;

FIG. 1B is a representative simplified view of an individual (or user) using wearable devices for user input or identification, in accordance with certain embodiments;

FIG. 2 is a representative partial cross-sectional view of a rig being utilized for a subterranean operation, in accordance with certain embodiments;

FIG. 3A is a representative front view of various individuals identifiable via an imaging system, in accordance with certain embodiments;

FIG. 3B is a representative flow diagram of a method for detecting and identifying an individual, in accordance with certain embodiments;

FIG. 4A is a representative list of activities for an example digital well plan, in accordance with certain embodiments;

FIG. 4B is a representative functional diagram that illustrates the conversion of well plan activities to rig plan tasks, in accordance with certain embodiments;

FIG. 5 is a representative functional diagram that illustrates possible databases used by a rig controller to convert a digital well plan to a digital rig plan, in accordance with certain embodiments;

FIG. 6 is a representative functional diagram that illustrates converting a digital well plan to a digital rig plan and mitigating an unplanned event while executing the digital rig plan, in accordance with certain embodiments; and

FIG. 7 is a representative functional diagram that illustrates a method for managing a performance index for individual drillers, in accordance with certain embodiments; and

FIG. 8 is a representative functional block diagram of a method using a computer to determine performance scores for various individuals and activities, in accordance with certain embodiments.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

As used herein, the terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise.

The use of the word “about”, “approximately”, or “substantially” is intended to mean that a value of a parameter is close to a stated value or position. However, minor differences may prevent the values or positions from being exactly as stated. Thus, differences of up to ten percent (10%) for the value are reasonable differences from the ideal goal of exactly as described. A significant difference can be when the difference is greater than ten percent (10%).

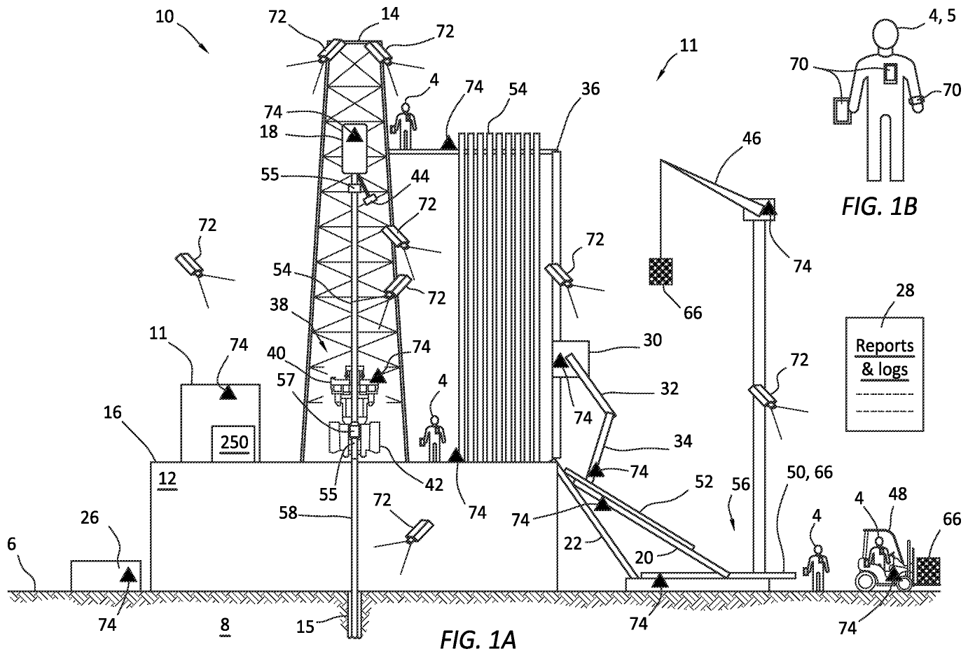

As used herein, “tubular” refers to an elongated cylindrical tube and can include any of the tubulars manipulated around a rig, such as tubular segments, tubular stands, tubulars, and tubular string, but not limited to the tubulars shown in FIG. 1A. Therefore, in this disclosure, “tubular” is synonymous with “tubular segment,” “tubular stand,” and “tubular string,” as well as “pipe,” “pipe segment,” “pipe stand,” “pipe string,” “casing,” “casing segment,” or “casing string.”

FIG. 1A is a representative simplified front view of a rig 10 at a rig site 11 being utilized for a subterranean operation (e.g., tripping in or out a tubular string to or from a wellbore), in accordance with certain embodiments. The rig site 11 can include the rig 10 with its rig equipment, along with equipment and work areas that support the rig 10 but are not necessarily on the rig 10. The rig 10 can include a platform 12 with a rig floor 16 and a derrick 14 extending up from the rig floor 16. The derrick 14 can provide support for hoisting the top drive 18 as needed to manipulate tubulars. A catwalk 20 and V-door ramp 22 can be used to transfer horizontally stored tubular segments 50 to the rig floor 16. A tubular segment 52 can be one of the horizontally stored tubular segments 50 that is being transferred to the rig floor 16 via the catwalk 20. A pipe handler 30 with articulating arms 32, 34 can be used to grab the tubular segment 52 from the catwalk 20 and transfer the tubular segment 52 to the top drive 18, the vertical storage area 36, the wellbore 15, etc. However, it is not required that a pipe handler 30 be used on the rig 10. The top drive 18 can transfer tubulars directly to and directly from the catwalk 20 (e.g., using an elevator 44 coupled to the top drive 18). Also, a catwalk 20 is not required, since one or more pipe handlers 30 can be used to transfer tubulars between storage locations (horizontal or vertical) and a well center.

FIG. 1A shows a land-based rig. However, it should be understood that the principles of this disclosure are equally applicable to off-shore rigs where “off-shore” refers to a rig with water between the rig floor and the earth surface 6.

When tripping the tubular string 58 out of the wellbore 15, tubulars 54 can be sequentially removed from the tubular string 58 to reduce the length of the tubular string 58 in the wellbore 15. The pipe handler 30 can be used to remove the tubulars 54 from an iron roughneck 38 or a top drive 18 at a well center 24 and transfer the tubulars 54 to the catwalk 20, the vertical storage area 36, other storage locations, etc. The iron roughneck 38 can break a threaded connection between a tubular 54 being removed and the tubular string 58. A spinner assembly 40 (or pipe handler 30) can engage a body of the tubular 54 to spin a pin end 57 of the tubular 54 out of a threaded box end 55 of the tubular string 58, thereby unthreading the tubular 54 from the tubular string 58.

When tripping the tubular string 58 into the wellbore 15, tubulars 54 are sequentially added to the tubular string 58 to increase the length of the tubular string 58 in the wellbore 15 extending through the surface 6 into the subterranean formation 8. The pipe handler 30 can be used to deliver the tubulars 54 to a well center on the rig floor 16 in a vertical orientation and hand the tubulars 54 off to an iron roughneck 38 or a top drive 18. The iron roughneck 38 can make a threaded connection between the tubular 54 being added and the tubular string 58. A spinner assembly 40 or pipe handler 30 can engage a body of the tubular 54 to spin a pin end 57 of the tubular 54 into a threaded box end 55 of the tubular string 58, thereby threading the tubular 54 into the tubular string 58. The wrench assembly 42 can provide a desired torque to the threaded connection, thereby completing the connection.

While tripping a tubular string into or out of the wellbore 15 can be a significant part of the operations performed by the rig and individual drillers, many other rig tasks are also needed to perform a well construction according to a digital well plan. For example, pumping mud at desired rates, maintaining downhole pressures (as in managed pressure drilling), maintaining and controlling rig power systems, maintaining and controlling rig equipment including downhole equipment to perform the subterranean operation, coordinating and managing personnel on the rig during the subterranean operation, performing pressure tests on sections of the wellbore 15, cementing a casing string in the wellbore 15, performing well logging operations, as well as many other rig tasks. As used herein, “personnel”, “individual”, “user”, or “operator” can be used interchangeably in that each refers to a human that is available to support a subterranean operation. As used herein, “individual driller” refers to an individual, user, or operator that controls (or at least oversees and manages) rig operations when performing digital well plan 100 activities at the rig site 11. Referring to an individual 4, a user, an operator, or personnel in this disclosure can be seen as also referring to an individual driller 5.

A rig controller 250 can be used by individual drillers to control the rig 10 operations including controlling various rig equipment, such as the pipe handler 30, the top drive 18, the iron roughneck 38, the vertical storage area equipment, imaging systems, various other robots on the rig 10 (e.g., a drill floor robot), rig power systems 26, or instructing individuals 4 on the rig 10. The rig controller 250 can control the rig equipment autonomously (e.g., without periodic operator interaction yet under the supervision of one or more individual drillers 5), semi-autonomously (e.g., with limited individual driller 5 interaction such as initiating a subterranean operation, adjusting parameters during the operation, etc.), or manually (e.g., with the individual driller 5 interactively controlling the rig equipment via remote control interfaces to perform the subterranean operation).

The rig controller 250 can include one or more processors with one or more of the processors distributed about the rig 10, such as in an individual driller's control hut 9, in the pipe handler 30, in the iron roughneck 38, in the vertical storage area 36, in the imaging systems, in various other robots, in the top drive 18, at various locations on the rig floor 16 or the derrick 14 or the platform 12, at a remote location 280 off of the rig 10, at downhole locations, etc. It should be understood that any of these processors, including processors in downhole locations, can perform control or calculations locally and report the results to the surface equipment, or can communicate to a remotely located processor for performing the control or calculations. The downhole processors can receive data from a plurality to data sources (e.g., sensors 72, 74) via one or more telemetry methods or systems for communicating with downhole tools, and the processors can transmit results of their calculations to the surface via the one or more telemetry methods or systems. Each of the processors can be communicatively coupled to a non-transitory memory, which can include instructions for the respective processor to read and execute to implement the desired control function. These processors can be coupled via a wired or wireless network. All data received and sent by the rig controller 250 is in a computer-readable format and can be stored in and retrieved from the non-transitory memory.

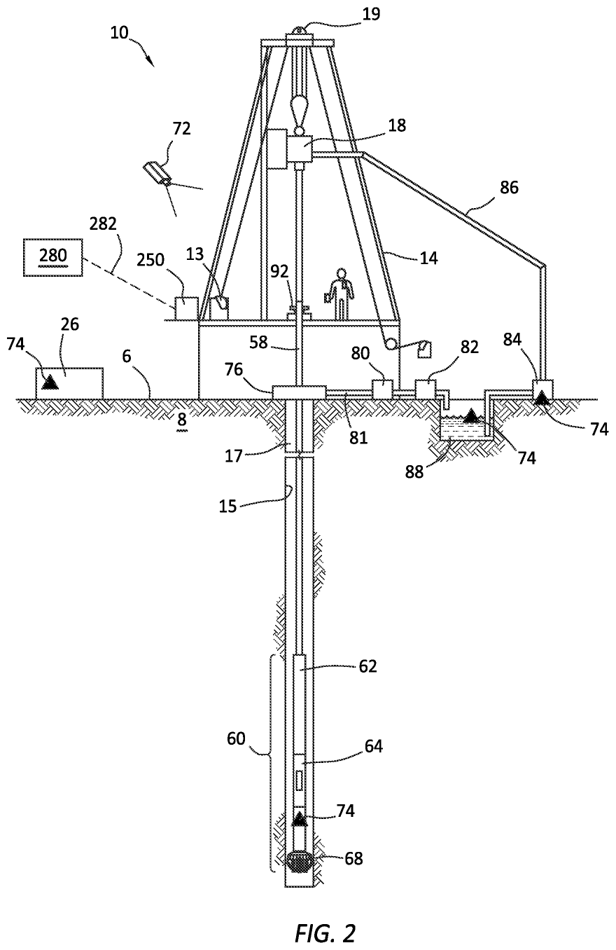

The rig controller 250 can be communicatively coupled to computers (which can be seen as a portion of the rig controller 250) at a remote location 280 (see FIG. 2), such that operators at the remote location 280 can use the data from the various data sources, as well as results based on one or more of the various data sources, to improve operations on the rig 10 (or at the rig site 11). The remote location can be a remote operations center, a remote home, a remote office, a remote satellite office, or any other location that can have one or more computers that are communicatively coupled to the rig controller 250 via a network 282, which can be a wired or wireless network or combinations thereof. The rig controller 250 can monitor activities of individuals 4 (or operators) at the remote location 280 or at the rig site 11 to track the activities of the individuals 4 and determine if these individuals 4 are involved with the rig (or rig site) operations and actively monitoring the rig operations. This two-way monitoring of individuals 4 between remote and local locations can improve the rig operations.

The rig controller 250 can collect data from various data sources around the rig (e.g., surface, and downhole sensors, user input, local rig reports, etc.) and from remote data sources (e.g., suppliers, manufacturers, transporters, company men, remote rig reports, etc.) to monitor and facilitate the execution of a digital well plan under the supervision of one or more individual drillers. A digital well plan 100 is generally designed to be independent of a specific rig, where a digital rig plan 102 is a digital well plan 100 that has been modified to incorporate the specific equipment available on a specific rig to execute the well plan on the specific rig, such as rig 10. Therefore, the rig controller 250 can be configured to monitor and facilitate the execution of the digital well plan 100 by monitoring and executing the digital rig plan 102. The rig controller 250 can also compare the actual performance to the digital well plan 100 to an expected performance of the digital well plan 100, and based on the comparison, determine a performance index for each of one or more individuals 4, one or more pieces of rig equipment, or one or more individual drillers 5.

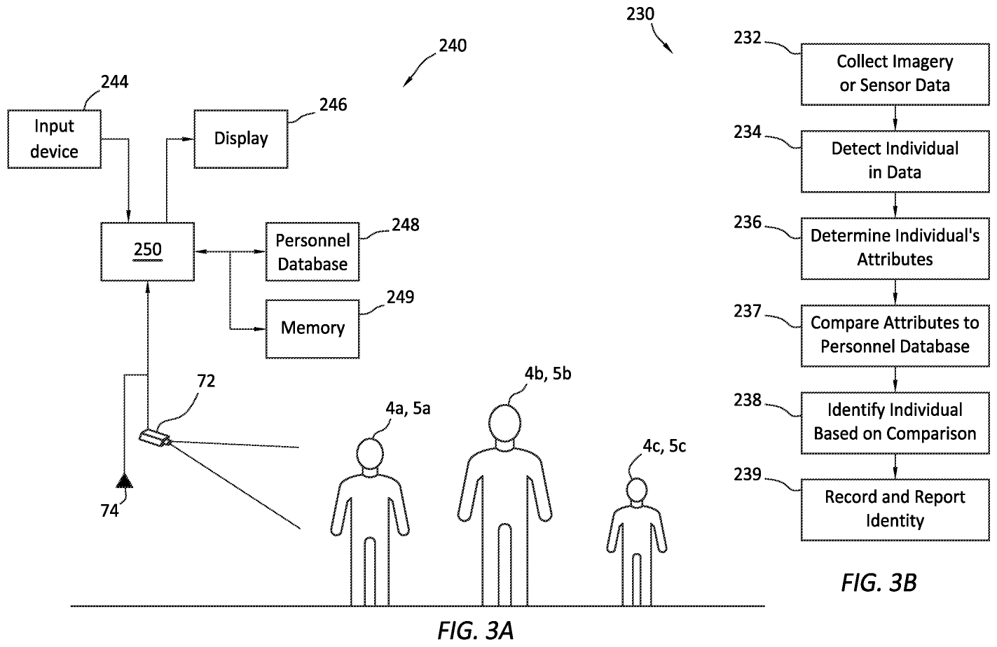

Examples of local data sources are shown in FIG. 1A where an imaging system (e.g., imaging system 240 in FIG. 3A) can include the rig controller 250 and imaging sensors 72 positioned at desired locations around the rig and around support equipment/material areas, such as mud pumps (see FIG. 2), horizontal storage area 56, power system 26, etc., to collect imagery of the desired locations. Also, various sensors 74 can be positioned at various locations around the rig site 11 and the support equipment/material areas to collect information from the rig equipment (e.g., pipe handler 30, roughneck 38, top drive 18, vertical storage 36, BHA 60, logging tool 64, etc.) and support equipment (e.g., crane 46, forklift 48, horizontal storage area 56, power system 26, shaker 80, return line 81, fluid treatment 82, pumps 84, standpipe 86, mud pit 88, etc.) to collect operational parameters of the equipment. As used herein, “rig equipment” refers to equipment used at the rig site 11, either on or off the rig 10 or downhole, which can include the support equipment described above. Additional information can be collected (via the rig controller 250 or via an individual 4) from other data sources, such as reports and logs 28 (e.g., tour reports, daily progress reports, reports from remote locations, shipment logs, delivery logs, personnel logs, etc.).

The data sources can also include wearables 70 (e.g., a smart wristwatch, a smart phone, a tablet, a laptop, an identification badge, a wearable transmitter, etc.) that can be worn by an individual 4 (or user 4) to identify the individual 4, deliver instructions to the individual 4, or receive inputs from the individual 4 via the wearable 70 to the rig controller 250 (see FIG. 1B). Network connections (wired or wireless) to the wearables 70 can be used for communication between the rig controller 250 and the wearables 70 for information transfer.

These data sources can be aggregated by the rig controller 250 and used to determine one or more dysfunctions during the execution of the digital well plan. As used herein, a “dysfunction” is an activity at a rig site 11 that causes the rig controller 250 to deviate from the current digital well plan or current digital rig plan. As used herein, the “current digital well plan” or “current well plan” refers to a digital well plan being executed at the rig site when the dysfunction is detected (e.g., via analysis of data sources) or otherwise determined (e.g., user input, etc.). As used herein, the “current digital rig plan” or “current rig plan” refers to the digital rig plan being executed when the dysfunction is detected (e.g., via analysis of data sources) or otherwise determined (e.g., user input, etc.), where the digital rig plan 102 (or rig plan 102) is an implementation of the digital well plan 100 (or well plan 100) on a specific rig (e.g., rig 10).

The dysfunction can be classified into at least three different categories. The dysfunction can be a “planned predictive dysfunction,” an “unplanned predictive dysfunction,” or an “unplanned reactive dysfunction.”

As used herein, a “planned predictive dysfunction” refers to one or more activities at a rig site (e.g., rig site 11) that were included in the digital well plan when the well plan was initially converted to a digital rig plan, but were included as alternative activities in the well plan that can be selected for the execution if an anticipated (or planned) dysfunction is detected. Therefore, the one or more activities for managing the anticipated dysfunction are included in the well plan when it is converted to the rig plan, but the one or more activities can be selected for the execution in the well plan when the anticipated dysfunction is detected, or not selected for the execution in the well plan when the anticipated dysfunction is not detected.

Therefore, the possible need for the one or more activities to be included in the digital well plan (and thus the digital rig plan) was anticipated prior to conversion of the well plan to the rig plan. For example, when the well plan is created, the designer(s) may understand that it is possible (and maybe highly likely) that a fluid loss condition may occur at a certain depth (e.g., such as a salt layer in the earthen formation 8) and that entering this salt layer via a drill string can cause fluid loss to occur. Therefore, the designers may include well activities in the original well plan to handle the anticipated dysfunction (e.g., the fluid loss condition), but the well activities are included as alternative activities to be executed in response to the dysfunction being detected. If the planned dysfunction is not detected, then the well activities may not be inserted into the rig plan 102 for execution.

Alternatively, the designers may provide a set of alternative well activities in a well activities database that can later be configured for a specific rig and inserted into the rig plan to handle the anticipated dysfunction if the anticipated dysfunction is detected. In this way, the designers can provide well activities that can manage the anticipated dysfunction without including the activities in the originally converted well plan. The designers can also alternatively or in addition to, provide a set of rig-specific tasks to be directly inserted into the current digital rig plan to manage the anticipated dysfunction without providing well plan activities that can be converted to rig tasks of a digital rig plan.

As used herein, an “unplanned reactive dysfunction” refers to an unanticipated dysfunction that is detected by the rig controller 250 or individual 4 (local individual 4 being on the rig 10 or remote individual 4 being off the rig 10) and selecting a pre-planned set of rig tasks from a rig task database that can be inserted into the current digital rig plan to manage the unanticipated dysfunction. Alternatively, or in addition to, a pre-planned set of activities from a well plan activities database can be inserted into the current digital well plan and converted to rig-specific tasks to be inserted into the current digital rig plan to manage the unanticipated dysfunction. For example, when a fluid loss condition is detected at a depth that the fluid loss condition was not anticipated, a pre-planned set of rig tasks can be inserted into the current digital rig plan to manage the unanticipated fluid loss that occurs at a certain depth of the wellbore 15.

Additionally, for example, when a fluid kick condition is detected at a certain depth where the fluid kick condition was not anticipated, a pre-planned set of rig tasks can be inserted into the current digital rig plan to manage the unanticipated fluid kick that occurs at a certain depth of the wellbore 15. Additionally, for example, when an equipment failure is detected that directly impacts the execution of the digital well plan, then a pre-planned set of rig tasks can be inserted into the current digital rig plan to manage the unanticipated equipment failure. It should be understood that the pre-planned set of rig tasks can include a pre-planned set of rig tasks created directly by the rig controller 250 or an individual 4, or they can include a pre-planned set of rig tasks that was converted from a pre-planned set of well plan activities to a set of rig specific tasks. For example, if mud pumps 1 and 2 are supporting a drilling operation, but failure of mud pump 2 is detected (i.e., an “unplanned reactive dysfunction”), then rig tasks can be determined and inserted into the digital rig plan 102 to use mud pumps 1 and 3 instead of 1 and 2 to work around the dysfunction.

As used herein, an “unplanned predictive dysfunction” refers to an unanticipated dysfunction that is detected by the rig controller 250 or individual 4 (local individual 4 being on the rig 10 or remote individual 4 being off the rig 10) and the unanticipated dysfunction is determined to occur in the near future. A pre-planned set of rig tasks for managing the unplanned dysfunction can be retrieved, via the rig controller 250, from a rig task database 267 and inserted into the current digital rig plan at an appropriate future time prior to the unplanned dysfunction occurring but does not have to alter the current rig plan immediately. The pre-planned set of rig tasks can be executed at the appropriate time in the future to manage the unanticipated dysfunction that has been predicted to happen in the near future (e.g., within the next week). Since the dysfunction is determined to occur prior to the dysfunction actually occurring, the dysfunction can be seen as being predicted prior to its occurrence. However, the unplanned predictive dysfunction can be seen as a dysfunction that was not highly anticipated or seen as likely to happen at the time the well plan was converted to the rig plan.

Alternatively, or in addition to, a pre-planned set of activities from a well plan activities database 258 can be inserted into the current digital well plan and converted to rig-specific tasks which can be inserted into the current digital rig plan at an appropriate future time prior to the unplanned dysfunction occurring. The unplanned dysfunction can be detected by the rig controller 250 or individual 4 and can be managed at a later time. It does not impact the current execution of the current digital rig plan tasks. For example, when a mud motor status indicates to the rig controller 250 or individual 4 that a future failure of the mud motor is predicted in the near future and that the one or more activities should be inserted into the digital well plan (and thus the digital rig plan) prior to a predicted timeframe of an occurrence of the dysfunction. For example, if mud pumps 1 and 2 are supporting a drilling operation, but a failure of mud pump 2 is predicted in the near future (i.e., an “unplanned predictive dysfunction”), then rig tasks can be determined and inserted into the digital rig plan 102 to use mud pumps 1 and 3 instead of 1 and 2 before mud pump 2 fails but the changes are not needed immediately since the failure is in the near future. Additionally, for example, when secondary activities (that are not included in the well plan activities but support timely execution of the well activities) are not being completed in a timely fashion (e.g., supply of tubulars running low, mud additives not available for upcoming mud conditioning activity, personnel not available for upcoming required task, etc.), then rig tasks may be added to the current rig plan to facilitate necessary workarounds for the dysfunctions.

FIG. 2 is a representative partial cross-sectional view of a rig 10 being used to drill a wellbore 15 in an earthen formation 8. FIG. 2 shows a land-based rig, but the principles of this disclosure can equally apply to off-shore rigs, as well. The rig 10 can include a top drive 18 with a traveling block 19 and drawworks 13 used to raise or lower the top drive 18. A derrick 14 extending from the rig floor, can provide the structural support of the rig equipment for performing subterranean operations (e.g., drilling, treating, completing, producing, testing, etc.). The rig can be used to extend a wellbore 15 through the earthen formation 8 by using a drill string 58 having a Bottom Hole Assembly (BHA) 60 at its lower end. Slips 92 in coordination with the top drive 18 and drawworks 13 can trip in and trip out the tubular string 58. The BHA 60 can include a drill bit 68 and multiple drill collars 62, with one or more of the drill collars including instrumentation (e.g., logging tool 64) for LWD and MWD operations. During drilling operations, drilling mud can be pumped from the surface 6 into the drill string 58 (e.g., via pumps 84 supplying mud to the top drive 18) to cool and lubricate the drill bit 68 and to transport cuttings to the surface via an annulus 17 between the drill string 58 and the wellbore 15.

The returned mud can be directed from the rotating control device 76 (if used) to the mud pit 88 through the flow line 81 and the shaker 80. A fluid treatment 82 can inject additives as desired to the mud to condition the mud appropriately for the current well activities and possibly future well activities as the mud is being pumped to the mud pit 88. The pump 84 can pull mud from the mud pit 88 and drive it to the top drive 18 to continue circulation of the mud through the drill string 58.

Sensors 74 and imaging sensors 72 can be distributed about the rig and downhole to provide information on the environments in these areas as well as operating conditions, health of equipment and individuals 4, well activity the equipment is performing, weight on bit (WOB), rate of penetration (ROP), revolutions per minute (RPM) of the drill string, RPM of the drill bit 68, downhole pressure, downhole temperature, surface temperature, the position of a valve whether opened, closed, or partially opened, level of fluid in a tank, amount of drilling fluid in the active systems, a property of the surrounding subterranean formation 8, depth of wellbore 15, length of tubular string 58, rheology of operational fluids, combinations thereof, etc.

FIG. 3A is a representative front view of various individuals 4a, 4b, 4c, 5a, 5b, 5c that can be detectable via an imaging system 240. The imaging system 240 can include the rig controller 250 and one or more imaging sensors 72 as well as other sensors 74, e.g., audio sensors. When determining the current well activity, it can be beneficial to detect how many individuals are present on the rig, where they are, who they are, and what they are doing. For example, one or more imaging sensors 72 can be used to detect individuals on the rig, track their location as they move about the rig, and determine the identity of each of the individuals. By receiving imagery from the one or more imaging sensors 72, the rig controller 250 can perform image recognition to detect the individuals (such as individuals 4a, 4b, 4c, individual drillers 5a, 5b, 5c, etc.) in the imagery. The rig controller 250 can also determine where each of the individuals are on the rig based on identification of the surroundings around the individuals in the imagery. The rig controller 250 can also determine the identity of each individual by determining attributes of the individual 4, where the attributes can include physical characteristics, mannerisms, walking motion, and voice (e.g., via audio sensors 74 included in the imaging system). The collected data can then be compared against a personnel database 248 to determine the unique identity of each individual 4. The rig controller 250 can record, report, or display the individual's identity (e.g., on display 246). An input device 244 can be used to provide input to the rig controller 250, such as to request identity verification or determination of an individual 4, which can include an individual driller 5.

FIG. 3B is a representative flow diagram of a method 230 for using the rig controller 250 to determine an identity of an individual 4 at the rig site 11. At operation 232, the rig controller 250 can autonomously (or as a result of a user request) collect imagery or other sensor data of one or more individuals 4 at the rig site 11 via the imaging sensor(s) 72 or other sensors 74. At operation 234, the rig controller 250 can detect the one or more individuals in the imagery or sensor data. In operation 236, the rig controller 250 can analyze the imagery or sensor data to determine the attributes of the individual 4. In operation 237, the rig controller 250 can compare the determined attributes to attributes in a personnel database 248. In operation 238, rig controller 250 can identify the individual 4 based on the comparison of the attributes. In operation 239, rig controller 250 can record the individual's identity and report the identity to interested users/individuals. With the identity of each of the individuals determined, the rig controller 250 can compare the actual individuals with the well plan and can use the comparison to improve the confidence level of the estimated well activity, determine a performance of the individuals to the well plan or rig plan, and compare the one or more identified individuals 4 to the resource allocations of the digital well plan 100 or digital rig plan 102.

After determining the unique identity of each individual 4, the rig controller 250 can determine the expertise/skills and experience level of the individual such as from a lookup table stored in non-transitory memory 249 which can be communicatively coupled to the rig controller 250. By knowing the unique identity of the individual, their skill set, and their location on the rig or in support areas, the rig controller 250 can assimilate this information along with the data from other various data sources to better determine the estimated well activity, determine a performance of the individual to the well plan or rig plan, and compare the one or more identified individuals 4 to the resource allocations of the digital well plan 100 or digital rig plan 102. If the estimated well activity is an expected well activity when compared to the digital well plan, then expected progress is likely being made in executing the digital well plan. If the performance of the individual is unsatisfactory compared to the well plan or rig plan, then corrective action can be taken to mitigate the low performance.

The who and where information of each individual 4 supporting the rig 10 can also be used to verify that the secondary operations are being performed in a timely manner so they do not become a primary activity. As used herein “primary activities” are those activities that are listed in the digital well plan, and as used herein “secondary operations” are those operations that provide support for the execution of the primary activities. Secondary operations can become primary activities if they do not adequately support the primary activities and cause delays in the primary activities by not being able to properly execute the primary activities.

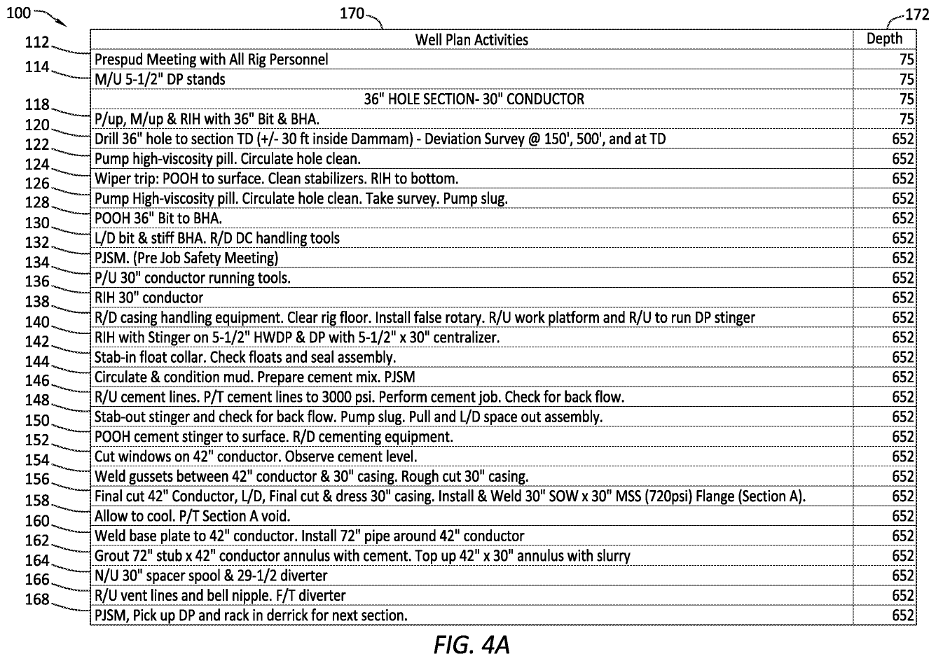

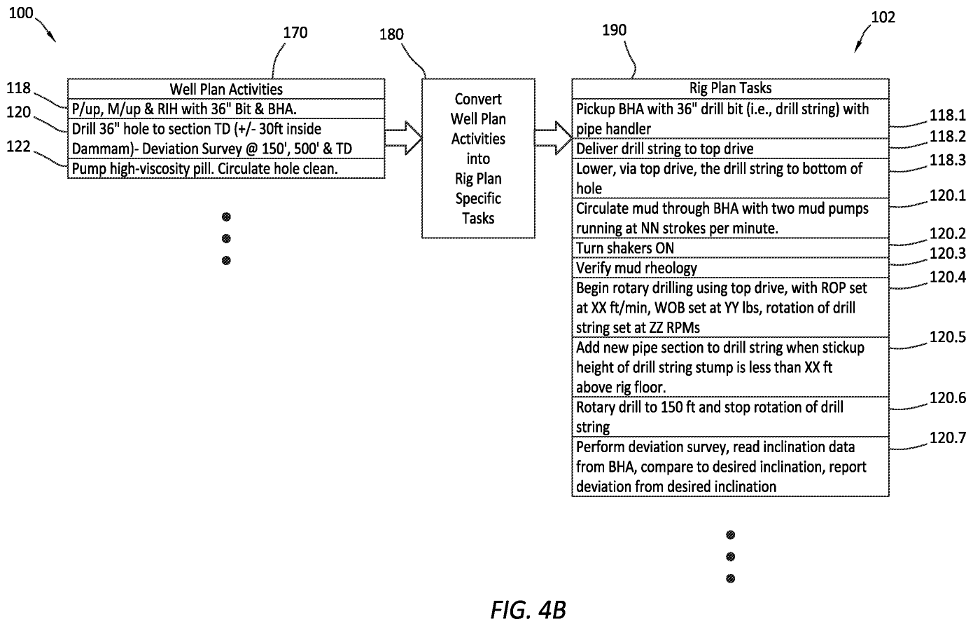

FIG. 4A is a representative list of activities 170 for an example digital well plan 100. This list of well plan activities 170 can merely represent a subset of a complete list of activities needed to execute a full digital well plan 100 to construct a wellbore 15 to a target depth (TD). The digital well plan 100 can include well plan activities 170 with corresponding target wellbore depths 172. However, these specific activities 170 are not required for the digital well plan 100. More or fewer activities 170 can be included in the digital well plan 100 in keeping with the principles of this disclosure. Therefore, the following discussion relating to the well plan activities 170 shown in FIG. 4A is merely an example to illustrate the concepts of this disclosure.

After the rig 10 has been utilized to drill the wellbore 15 to a depth of 75, at activity 112, a Prespud meeting can be held to brief all rig personnel on the goals of the digital well plan 100.

At activity 114, the appropriate personnel and rig equipment can be used to make-up (M/U) 5½″ drill pipe (DP) stands in prep for the upcoming drilling operation. This can for example require a pipe handler and horizontal or vertical storage areas for tubular segments or tubular stands. The primary activities can be seen as the make-up of the drill pipe (DP) stands, with the secondary operations being, for example, availability of tubular segments to build the DP stands; availability of a pipe handler (e.g., pipe handler 30) to manipulate the tubulars; a torquing wrench and backup tong for torquing joints when assembling the DP stands, a horizontal storage area, a vertical storage area; available space in a storage area for the DP stands; doping compound and doping device available for cleaning and doping threads of the tubulars 50; or appropriate personnel to support these operations.

At activity 118, the appropriate personnel and rig equipment can be used to pick up (P/up), makeup (M/up), and run-in hole (RIH) a BHA with a 36″ drill bit 68. This can, for example, require BHA components; a pipe handler to assist in the assembly of the BHA components; a pipe handler to deliver BHA to a top drive; and lowering the top drive to run the BHA into the wellbore 15. The primary activities can be seen as assembling the BHA and lowering the BHA into the wellbore 15. The secondary operations can be delivering the BHA components, including the drill bit, to the rig site; monitoring the health of the equipment to be used; and ensuring personnel available to perform tasks when needed.

At activity 120, the appropriate personnel and rig equipment can be used to drill 36″ hole to a TD of the section, such as 652 ft, to +/−30 ft inside a known formation layer (e.g., Dammam), and performing a deviation survey at depths of 150′, 500′ and TD (i.e., 652′ in this example). The primary activities can be seen as repeatedly feeding tubulars (or tubular stands 54) via a pipe handler to the well center from a tubular storage for connection to a tubular string 58 in the wellbore 15; operating the top drive 18, the iron roughneck 38, and slips to connect tubulars 50 (or tubular stands 54) to the tubular string 58; cleaning and doping threads of the tubulars 50, 54; running mud pumps to circulate mud through the tubular string 58 to the bit 68 and back up the annulus 17 to the surface; running shakers; injecting mud additives to condition the mud; rotating the tubular string 58 or a mud motor (not shown) to drive the drill bit 68, and performing deviation surveys at the desired depths.

The secondary operations can be seen as having tubulars 50 (or tubular stands 54) available in the horizontal storage or vertical storage locations and accessible via the pipe handler. If coming from the horizontal storage 56, then the tubulars 50 can be positioned on horizontal stands, with individuals 4 operating handling equipment, such as forklifts 48 or crane 46, to keep the storage area 56 stocked with the tubulars 50. If coming from the vertical storage area 36, then the rig personnel 4 (or rig controller 250), can make sure that enough tubular stands 54 (or tubulars 50) are racked in the vertical storage area 36 and accessible to the pipe handler 30 (or another pipe handler if needed). Additional secondary operations can be seen as ensuring that the doping compound and doping device are available for cleaning and doping threads of the tubulars 50; mud additives are available for an individual 4 (e.g., mud engineer) or an automated process to condition the mud as needed; the necessary equipment is available and operational to support the activity 120, such as the top drive 18 (including drawworks), iron roughneck 38, slips, and pipe handlers; and ensuring the power system 26 is configured to support the drilling operation.

At activity 122, the appropriate personnel and rig equipment can be used to pump a high-viscosity pill through the wellbore 15 via the tubular string 58 and then circulate wellbore 15 clean. The primary activities can be seen as injecting mud additives into the mud to create the high-viscosity pill, mud pumps operating to circulate the pill through the wellbore 15 (down through the tubular string 58 and up through the annulus 17); slips to hold tubular string 58 in place; top drive 18 connected to tubular string 58 to circulate mud; and, after pill is circulated, circulating mud through the wellbore 15 to clean the wellbore 15. The secondary operations can be ensuring the power system 26 is configured to support the mud circulation activities; the mud pumps 84 are configured to supply the desired pressure and flow rate of fluid to the tubular string 58; and that the mud additives are available for an individual 4 (e.g., mud engineer) or an automated process to condition the mud as needed.

At activity 124, the appropriate personnel and rig equipment can be used to perform a “wiper trip” by pulling the tubular string 58 out of the hole (Pull out of hole—POOH) to the surface 6; clean stabilizers on the tubular string 58; and run the tubular string 58 back into the hole (Run in hole—RIH) to the bottom of the wellbore 15. The primary activities can be seen as operating the top drive 18, the iron roughneck 38, and slips to disconnect tubulars 50 (or tubular stands 54) from the tubular string 58; moving the tubulars 50 (or tubular stands 54) to vertical storage 36 or horizontal storage 56 via a pipe handler, equipment and personnel/individuals 4 to clean the stabilizers; and operating the top drive 18, the iron roughneck 38, and slips to again connect tubulars 50 (or tubular stands 54) to the tubular string 58 while running the tubular string 58 back into the wellbore 15.

The secondary operations can be seen as having the necessary equipment to support the activity 124 is operational, such as the top drive 18 (including drawworks), iron roughneck 38, slips, and pipe handlers operational; ensuring the power system 26 is configured to support the tripping out and tripping in operations; and ensuring that the appropriate individual(s) 4 and cleaning equipment are available to perform stabilizer cleaning when needed.

At activities 126 thru 168, the appropriate personnel and rig equipment can be used to perform the indicated well plan activities. The primary activities can be seen as the personnel, equipment, or materials 66 needed to directly execute the well plan activities using the specific rig 10. The secondary operations can be those activities that ensure the personnel, equipment, or materials 66 are available and configured to support the primary activities.

FIG. 4B is a functional diagram that can illustrate the conversion of well plan activities 170 to rig plan tasks 190 of a rig-specific digital rig plan 102. When a well plan 100 is designed, well plan activities 170 can be included to describe primary activities needed to construct a desired wellbore 15 to a TD. However, the well plan 100 activities 170 are not specific to a particular rig, such as rig 10. It may not be appropriate to use the well plan activities 170 to direct operations on a specific rig, such as rig 10. Therefore, a conversion of the well plan activities 170 can be performed to create a list of rig plan tasks 190 of a digital rig plan 102 to construct the desired wellbore 15 using a specific rig, such as rig 10. This conversion engine 180 (which can run on a computing system such as the rig controller 250) can take the non-rig specific well plan activities 170 as an input and convert each of the non-rig specific well plan activities 170 to a series of rig specific tasks 190 to create a digital rig plan 102 that can be used to direct activities on a specific rig, such as rig 10, to construct the desired wellbore 15.

As a way of example, a high-level description of the conversion engine 180 will be described for a subset of well plan activities 170 to demonstrate a conversion process to create the digital rig plan 102. The well plan activity 118 states, in abbreviated form, to pick up, make up, and run-in hole a BHA 60 with a 36″ drill bit. The conversion engine 180 can convert this single non-rig-specific activity 118 into, for example, three rig-specific tasks 118.1, 118.2, 118.3. Task 118.1 can instruct the rig operators or rig controller 250 to pickup the BHA 60 (which has been outfitted with a 36″ drill bit) with a pipe handler. At task 118.2, the pipe handler can carry the BHA 60 and deliver it to the top drive 18, with the top drive 18 using an elevator to grasp and lift the BHA 60 into a vertical position. At task 118.3, the top drive 18 can lower the BHA 60 into the wellbore 15 which has already been drilled to a depth of 75′ for this example as seen in FIG. 4A. The top drive 18 can lower the BHA 60 to the bottom of the wellbore 15 to have the drill bit 68 in position to begin drilling as indicated in the following well activity 120.

The well plan activity 120 states, in abbreviated form, to drill a 36″ hole to a target depth (TD) of the section, such as 652 ft, to +/−30 ft inside a known formation layer (e.g., Dammam), and performing a deviation survey at depths of 150′, 500′ and TD (i.e., 652′ in this example). The conversion engine 180 can convert this single non-rig-specific activity 120 into, for example, seven rig-specific tasks 120.1 to 120.7. Task 120.1 can instruct the rig operators or rig controller 250 to circulate mud through the top drive 18, through the drill string 58, through the BHA 60, and exiting the drill string 58 through the drill bit 68 into the annulus 17. For this example, the mud flow requires two mud pumps 84 to operate at “NN” strokes per minute, where “NN” is a desired value that delivers the desired mud flow and pressure. At task 120.2, the shaker tables can be turned on in preparation for cuttings that should be coming out of the annulus 17 when the drilling begins. At task 120.3, a mud engineer can verify that the mud characteristics are appropriate for the current tasks of drilling the wellbore 15. If the rheology indicates that mud characteristics should be adjusted, then additives can be added to adjust the mud characteristics as needed.

At task 120.4, rotary drilling can begin by lowering the drill bit into contact with the bottom of the wellbore 15, and rotating the drill bit by rotating the top drive 18 (e.g., rotary drilling). The drilling parameters can be set to be “XX” ft/min for rate of penetration (ROP), “YY” lbs for weight on bit (WOB), and “ZZ” revolutions per minute (RPM) of the drill bit 68.

At task 120.5, as the wellbore 15 is extended by the rotary drilling when the top end of the tubular string 58 is less than “WW” ft above the rig floor 16, then a new tubular segment (e.g., tubular, tubular stand, etc.) can be added to the tubular string 58 by retrieving a tubular segment 50, 54 from tubular storage via a pipe handler, stop mud flow and disconnect the top drive from the tubular string 58, hold the tubular string 58 in place via the slips at well center, raise the top drive 18 to provide clearance for the tubular segment to be added, transfer tubular segment 50, 54 from the pipe handler 30 to the top drive 18, connect the tubular segment 50, 54 to the top drive 18, lower the tubular segment 50, 54 to the stump of the tubular string 58 and connect it to the tubular string 58 using a roughneck to torque the connection, then start mud flow. This can be performed each time the top end of the tubular string 58 is lowered below “WW” ft above the rig floor 16.

At task 120.6, add tubular segments 50, 54 to the tubular string 58 as needed in task 120.5 to drill wellbore 15 to a depth of 150 ft. Stop rotation of the drill bit 68 and stop mud pumps 84.

At task 120.7, perform a deviation survey by reading the inclination data from the BHA 60, comparing the inclination data to expected inclination data, and report deviations from the expected. Correct drilling parameters if deviations are greater than a pre-determined limit.

The conversion from a well plan 100 to a rig-specific rig plan 102 can be performed manually or automatically with the best practices and equipment recipes known for the rig that can be used in the wellbore construction.

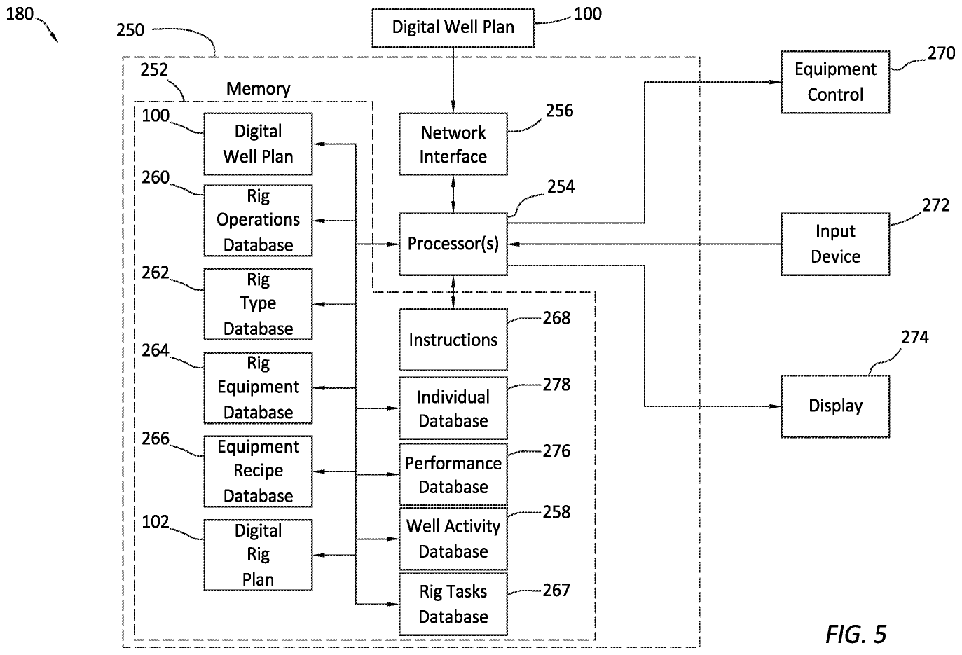

FIG. 5 is a representative functional block diagram of the rig plan conversion engine 180 that can include possible databases used by a rig controller 250 to convert a digital well plan 100 to a digital rig plan 102, for identifying individuals detected in work zones on the rig 10, storing and providing historical performance data (e.g., performance database 276). The rig plan conversion engine 180 can be a program (i.e., list of instructions 268) that can be stored in the non-transitory memory 252 and executed by processor(s) 254 of the rig controller 250 to convert a digital well plan 100 to a digital rig plan 102 or identify individuals 4 on the rig 10.

A digital well plan 100 can be received at an input to the rig controller 250 via a network interface 256. The digital well plan 100 can be received by the processor(s) 254 and stored in the memory 252. The processor(s) 254 can then begin reading the sequential list of well plan activities 170 of the digital well plan 100 from the memory 252. The processor(s) 254 can process each well plan activity 170 to create rig-specific tasks to implement the respective activity 170 on a specific rig (e.g., rig 10).

To convert each well plan activity 170 to rig-specific tasks for a rig 10, processor(s) 254 must determine the equipment available on the rig 10, the best practices, operations, and parameters for running each piece of equipment, and the operations to be run on the rig to implement each of the well plan activities 170.

Referring again to FIG. 5, the processor(s) 254 are communicatively coupled to the non-transitory memory 252 which can store multiple databases for converting the well plan 100 into the rig plan 102, for identifying individuals detected in work zones on the rig 10, and for storing performance scores. The databases identified in this disclosure may be described as being separate, but the databases can be combined in a single database or organized in multiple databases that combine some databases into one database with other databases combined into another database. For example, the individual database 278 can be combined with the performance database 276. They are described as being separate for purposes of discussion. The databases identified in this disclosure may be solely included in controllers at the rig site 11, solely included in controllers at one or more remote locations 280, or replicated to one or more remote locations 280 or one or more local locations at the rig site 11.

A rig operations database 260 includes rig operations for implementing each of the well plan activities 170. Each of the rig operations can include one or more tasks to perform the rig operation. The processor(s) 254 can retrieve those operations for implementing the first rig activity 170 from the rig operations database 260 including the task lists for each operation. The processor(s) 254 can receive a rig type RT from a user input or the network interface 256. With the rig type RT, the processor(s) 254 can retrieve a list of equipment available on the rig 10 from the rig type database 262, which can contain equipment lists for a plurality of rig types.

The processor(s) 254 can then convert the operational tasks to rig specific tasks to implement the operations on the rig 10. The rig specific tasks can include the appropriate equipment for rig 10 to perform the operation task. The equipment selection for each rig specific task can also be determined, at least in part, based on a performance score for each rig equipment, where the performance scores can indicate a historical ability of the equipment to perform the particular task. The processor(s) 254 can retrieve performance scores for the rig equipment from the performance database 276 and use the performance scores to better allocate rig equipment (e.g., stored in a rig equipment database 264) to the particular rig specific tasks.

The processor(s) 254 can then collect the recipes for operating each of the available equipment for rig 10 from the recipes database 266, where the recipes can include best practices on operating the equipment, preferred parameters for operating the equipment, and operational tasks for the equipment (such as turn ON procedures, ramp up procedures, ramp down procedures, shutdown procedures, etc.). Performance of the rig site 11 to the well plan 100 can be determined based upon recipes selected for controlling rig equipment, with these recipes being determined based on performance scores of one or more individual drillers 5. Therefore, selection of the recipes for setting up, running, or controlling the rig equipment can be based on the performance scores of one or more individual drillers 5. Also, the performance scores of one or more individual drillers 5 can be adjusted or determined based on the execution of a portion of the digital rig plan 102 based on the recipes selected by the one or more individual drillers 5.

When the rig specific tasks of the rig plan 102 are defined and the rig equipment is allocated to each task of the rig plan 102, the processor(s) 254 can then allocate one or more individuals 4 to each of the rig plan 102 tasks, including one or more individual drillers 5. Similar to the allocation of the rig equipment, the processor(s) 254 can retrieve performance scores from the performance database 276 for each of the individuals in the individual database 278 for performing the particular task and select the best individual(s) for performing the particular task. The processor(s) 254 can allocate the individuals 4 at least partially based on the retrieved performance scores, but the processor(s) 254 can also adjust allocations of the individuals to level out the work to be done across the available workforce even when a performance score may possibly indicate another individual(s) to perform a particular task. If the performance scores for the individuals or rig equipment are adjusted during the execution of the rig plan 102, then the adjusted performance scores can be stored back in the performance database 276 for future utilization.

The processor(s) 254 can also allocate the individual drillers 5 as needed based on their performance scores. The performance score for an individual driller 5 indicates a historical ability of the individual driller 5 to meet the expected performance metrics of the digital well plan 100. If the performance score for the individual driller 5 is equal to or above a predetermined value, then the individual driller 5 can be seen as meeting or exceeding the expected performance metrics of the digital well plan 100. If the performance score for the individual driller 5 is below the predetermined value, then the individual driller 5 can be seen as under-performing to the expected performance metrics of the digital well plan 100. If below the predetermined value, actions can be taken to improve the performance score of the individual driller 5, such as training, supplying a mentor to coach the individual driller 5 during drilling operations, or otherwise improving the performance score.

Therefore, the processor(s) 254 can retrieve each of the well plan activities 170 and convert them to a list of rig specific tasks that can perform the respective well plan activity 170 on the rig 10. After converting all of the well plan activities 170 to rig specific tasks 190 and creating a sequential list of the tasks 190, the processor(s) 254 can store the resulting digital rig plan 102 in the memory 252. When the rig 10 is operational and positioned at the proper location to drill a wellbore 15, the rig controller 250, via the processor(s) 254, can begin executing the list of tasks in the digital rig plan 102 by sending control signals and messages to the equipment control 270.

The rig controller 250 can also receive user input from an input device 272 or display information to a user or individual 4 via a display 274. The input device 272 in cooperation with the display 274 can be used to input well plan activities, initiate processes (such as converting the digital well plan 100 to the digital rig plan 102), select alternative activities, or rig tasks during the execution of digital well plan 100 or digital rig plan 102, or monitor operations during well plan execution. The input device 272 can also include the sensors 74 and the imaging sensors 72, which can provide sensor data (e.g., image data, temperature sensor data, pressure sensor data, operational parameter sensor data, etc.) to the rig controller 250 for determining the actual well activity of the rig.

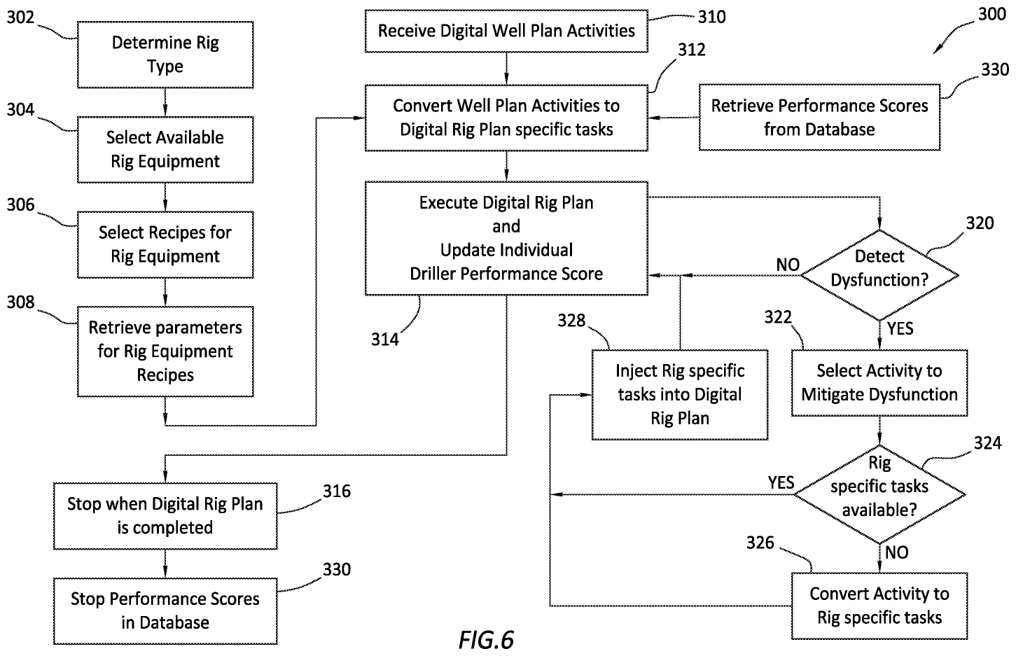

FIG. 6 is a representative functional diagram that illustrates a method 300 for converting a digital well plan 100 to a digital rig plan 102, mitigating a detected dysfunction while executing the digital rig plan 102, and updating performance scores for one or more individual drillers 5 as the well plan 100 is being executed. At operation 310, the rig controller 250 can receive the activities from the digital well plan 100 and transfer it to the conversion engine 180 for operation 312. At operation 302, the rig controller 250 can determine the rig type RT, and in operation 304 use the rig type to select the list of available rig equipment from the rig type database 262. In operation 306, the rig controller 250 can retrieve recipes for operating the available rig equipment from the recipes database 266. In operation 308, the rig controller 250 can retrieve operating parameters for the recipes from the recipes database 266. In operation 330, the rig controller 250 can retrieve performance scores for the rig equipment, individuals 4, and individual drillers 5 and transfer the performance scores to the operation 312. In operation 312, the rig controller 250 can use the data received from operations 302, 304, 306, 308 310, and 330 to convert the digital well plan 100 activities 170 to digital rig plan 102 tasks 190 along with operations collected from the rig operations database 260 for performing each activity 170.

In operation 314, the rig controller 250 can begin executing the digital rig plan 102. During the execution of the digital rig plan 102, the rig controller 250 can continuously (or at least periodically or on an as needed basis) receive data from the multiple data sources and aggregate the data to determine the current state of the rig operations, the current activity of the well plan 100 being performed, the current rig task being performed, the adherence of the current well activity to track the expected performance of the digital well plan 100 and use the performance information to update the one or more individual drillers 5 that are controlling the rig site operations for the time period the performance data is being collected.

The aggregated data from the multiple data sources can also be used to determine if the current well activity is a planned well activity or an unplanned or unexpected well activity at the current time. In operation 320, the rig controller 250 can monitor the health of the rig operations and detect a dysfunction that may be occurring or will occur in the near future. If a dysfunction is not detected, then the execution of the digital rig plan 102 can continue with the rig controller 250 proceeding back to operation 314. However, if a dysfunction is detected, then the rig controller 250, under the supervision of an individual driller 5, can proceed to operation 322. A performance score for an individual driller 5 can be positively or negatively impacted based on how well the individual driller 5 manages the detected dysfunction. A performance score for an individual driller 5 can be determined for the performance of the rig tasks injected into the rig plan 102 based on how well the individual driller 5 manages the detected dysfunction. Therefore, the activities or tasks performed to manage the dysfunction can be used to determine an overall performance score for the dysfunction management.

In operation 322, the rig controller 250 can select one or more well activities 170 that can be used to mitigate (or manage) the dysfunction so the rig controller 250 can return to executing the digital rig plan 102 once the dysfunction is mitigated. The performance score of the individual driller 5 can also be used to determine or at least influence the selection of the one or more well activities 170 that can be used to mitigate (or manage) the dysfunction. It should be noted that the one or more well activities 170 can be pre-planned well activities 170 that were included in the initial digital well plan 100 prior to conversion to the digital rig plan 102. Therefore, the rig-specific tasks 190 for implementing the pre-planned well activities 170 can already be available in the digital rig plan 102. Therefore, the rig controller 250 (or individual driller 5) can initiate execution of the rig-specific tasks 190 for implementing the pre-planned well activities 170.

If the detected dysfunction was not a planned predictive dysfunction, then it may possibly be an unplanned predictive dysfunction or an unplanned reactive dysfunction. If the dysfunction is an unplanned predictive dysfunction, then the rig controller 250 (or individual 4) can select one or more well activities 170 to mitigate the dysfunction. As stated above, the performance score of the individual driller 5 can also be used to determine or at least influence the selection of the one or more well activities 170 that can be used to mitigate (or manage) the dysfunction. In operation 324, the rig controller 250 can check to see if there are already rig-specific tasks 190 in the rig tasks database 267 to implement the one or more well activities 170. If so, the rig controller 250 can inject the rig-specific tasks 190 (in operation 328) into the digital rig plan 102 for execution in operation 314.

If not, the rig controller 250 can convert the one or more well activities 170 to rig specific tasks 190 (in operation 326) and inject the rig specific tasks 190 (in operation 328) into the digital rig plan 102 for execution in operation 314. However, injecting the rig-specific tasks 190 into the digital rig plan 102 does not require the rig controller 250 to immediately begin execution of the rig-specific tasks 190 to mitigate the dysfunction, since the dysfunction is an unplanned predictive dysfunction. The rig controller 250 can determine the best time to mitigate the dysfunction by selecting a start time for the execution of the rig-specific tasks 190 for mitigating the dysfunction. The rig controller 250 can continue to execute the digital rig plan 102 in operation 314 until the desired time (or start time) to mitigate the unplanned predictive dysfunction has come.

If the dysfunction is an unplanned reactive dysfunction, then the rig controller 250 (or individual 4) can select one or more well activities 170 to mitigate the dysfunction. As stated above, the performance score of the individual driller 5 can also be used to determine or at least influence the selection of the one or more well activities 170 that can be used to mitigate (or manage) the dysfunction. In operation 324, the rig controller 250 can check to see if there are already rig-specific tasks 190 in the rig tasks database 267 to implement the one or more well activities 170. If so, the rig controller 250 can inject the rig-specific tasks 190 (in operation 328) into the digital rig plan 102 for execution in operation 314. If not, the rig controller 250 can convert the one or more well activities 170 to rig specific tasks 190 (in operation 326) and inject the rig specific tasks 190 (in operation 328) into the digital rig plan 102 for execution in operation 314. For this kind of dysfunction, execution of the digital rig plan 102 may already be impacted, so more often than not, the rig controller 250 may begin executing the rig specific tasks 190 for mitigating the dysfunction as soon as they are injected into the digital rig plan 102 in operation 328. When the digital rig plan 102 is completed and the wellbore 15 is drilled to its target depth TD, then the drilling operations on the rig 10 can stop in operation 316.

In operation 314, as the rig controller 250, under the supervision of one or more individual drillers 5, is executing the digital well plan 100, the rig controller 250 can measure the performance of the rig 10 or rig site 11 to the well plan 100 and associate the success or lack thereof to the one or more individual drillers 5 that are in control of the subterranean operation and calculate a performance score for each of the one or more individual drillers 5.

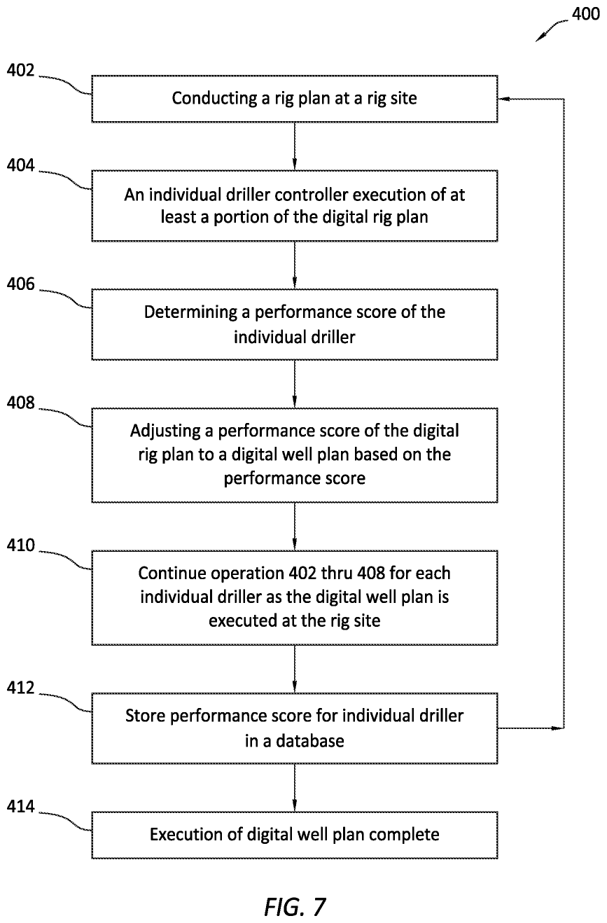

FIG. 7 is a representative functional diagram that illustrates a method 400 for determining a performance score for a digital rig plan 102 to a digital well plan 100 based on performance scores of individual drillers 5. In operation 402, the rig controller 250, under supervision of one or more individual drillers 5, can execute a digital rig plan 102 at a rig site 11 via controlling or managing rig resources, such as rig equipment or individuals 4. As described above, the digital rig plan 102 can be established by converting a digital well plan 100 to a rig specific list of tasks. In operation 404, an individual driller 5 can control the execution of at least a portion of the digital rig plan 102. The individual driller 5 can use the rig controller 250 to monitor and control the rig resources to execute the portion of the digital rig plan 102.

In operation 406, the rig controller 250 can collect data from the multiple data sources and use the data to determine a performance of the rig resources to execute the portion of the digital rig plan 102 to the digital well plan 100. Based on the performance of the rig resources, the rig controller 250 can calculate a performance score for the individual driller 5 for the portion of the digital rig plan 102. In operation 408, the rig controller 250 can adjust an overall performance score for the digital rig plan 102 based on the execution of the portion of the digital rig plan 102 by the individual driller 5. In operation 410, operations 402 thru 408 can be repeated with the same individual driller 5 or another individual driller 5 until the digital rig plan 102 is completed.

In operation 412, the rig controller 250 can store the performance scores for the individual driller 5 and the overall performance score for the digital rig plan 102 in a database as each iteration of operations 404 thru 408 are repeated. When all portions of the digital rig plan 102 are completed, the subterranean operation can stop in operation 414.

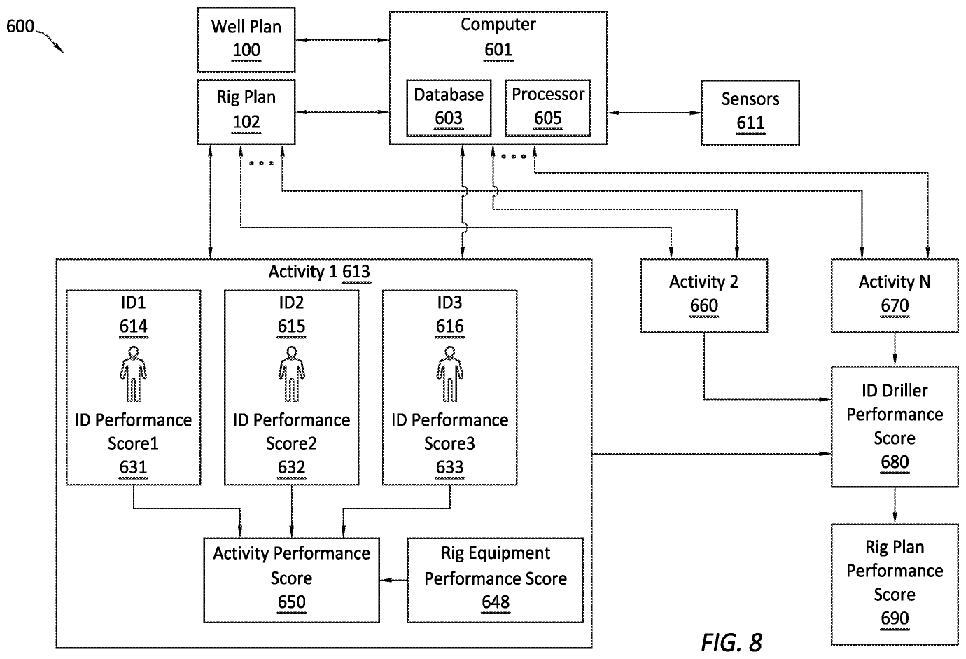

FIG. 8 is a functional block diagram of a method 600 using a computer 601 (which can also be referred to as the rig controller 250) to determine performance scores 631, 632, 633, 648, 650, 680, 690 for various individuals, rig equipment, activities 613, 660, individual driller 5, and the digital rig plan 102. The computer 601 (or rig controller 250 or conversion engine 180), as described in more detail regarding FIGS. 4A, 4B, 5, can receive a digital well plan 100 and convert the digital well plan 100, via processor(s) 605 and one or more databases 603, into a rig specific digital rig plan 102 for executing the digital well plan 100 on the rig 10. The computer 601 can receive sensor data from sensors 611 (e.g., sensors 72, 74). The rig 10 can begin executing one or more well activities, such as activity 613, activity 660, or activity 670. These can be serial activities that are executed one after another, or they can be parallel activities where, for example, at least a portion of the activity 660 is performed simultaneously with at least a portion of the activity 613.

Before the activity 613 is executed, the computer 601 can establish an initial performance score component for the individuals 4, rig equipment, activities 613, 660, and individual driller 5. The initial performance score component can be determined from historical performance data or determined through simulation of the rig plan 102 based on the current rig environment and current risk factors. The initial performance score component can be used to allocate resources to the tasks and activities.

During the execution of at least one of the activities 613, 660, the rig controller 250 can collect sensor data from the sensors 611 and use the sensor data to determine an estimated activity based on the sensor data and then compare the sensor data to reference data for an expected activity stored in a database to verify that the estimated activity is the actual activity being performed. The reference data can include historical data collected from previously completed activities. The reference data can include a list of rig tasks and associated sensor data that occurs for each of the rig tasks. Comparing the sensor data to the list of rig tasks and associated sensor data can be used to identify the actual activity being performed within the environment.

During the execution of at least one of the activities 613, 660, the rig controller 250 can collect sensor data from the sensors 611 and use the sensor data to determine an estimated task for each individual based on the sensor data and then compare the sensor data to reference data stored in a database to verify that the estimated task is the actual task being performed. The reference data can include historical data collected from previously completed tasks. An actual task of the individual can include referencing a database with stored information related to the actual task of the individual or sensing the actual task of the individual via one or more sensors monitoring the environment, or actively confirming the actual task of the individual with the individual via an electronic device; or combinations thereof. The identification of the actual task of the individual 4 can be confirmed by referencing a database having stored information related to the task of the individual or sensing the task of the individual via one or more sensors in the environment, or actively confirming the task of the individual with the individual via the electronic device.

During the execution of the activities 613, 660, the computer 601 can collect sensor data from the sensors 611 and use the sensor data to determine a real-time performance score component that can be used to modify the initial performance scores in real-time to determine a real-time performance score. The real-time performance score can indicate a real-time comparison of the real-time performance scores to expected performance metrics of the digital well plan 100, such as satisfactory completion of the task or activity according to the digital well plan 100 (or digital rig plan 102).

The computer 601 can use the sensor data from various data sources to identify each of the individuals 4 (e.g., individuals 614, 615, 616) that may be assigned to perform a task or may be performing a task. The computer 601 can also determine the task to be performed or the task being performed by each individual based on either the digital rig plan 102, sensor data, or both. The computer 601 can determine a performance score 631, 632, 633 for the respective individual 614, 615, 616. The performance score 631, 632, 633 can be determined by combining an initial individual performance score component with a real-time performance score component as described above. One or more of the individuals 614, 615, 616 can be located at the remote location 280, where the one or more of the individuals 614, 615, 616 can make decisions about the rig operations which can impact the performance of the rig operations. For example, the one or more of the individuals 614, 615, 616 can make a decision to alter a parameter or recipe of a task of the digital rig plan 102. The decision can be at least one of a directional steering decision, a geological steering decision, a well control decision, a mud weight decision (e.g., controlled pressure drilling), a hydrostatic pressure decision (e.g., controlled pressure drilling), or combinations thereof. These decisions can be evaluated by the computer 601 (or rig controller 250) to determine a performance score for the task the decision affected.

The computer 601 can determine a performance score 648 for the rig equipment that may be used for performing tasks of the activity 613, 660. The performance score 648 can be determined by combining an initial individual performance score component with a real-time performance score component as described above. The computer 601 can then calculate an activity performance score 650 that incorporates the individual performance scores 631, 632, 633, and the rig equipment performance score 648 (if used) into an overall activity performance score that can indicate the current performance of the rig 10 to the digital well plan 100 (or digital rig plan 102).

The performance scores 631, 632, 633, 648, 650 can be determined for other activities, such as Activity 2 through Activity N, for which the individual driller 5 is supervising. The performance scores 650 can be used to calculate a performance score 680 for the individual driller 5. A similar method 600 can be performed for each individual driller 5 and the one or more activities (or list of tasks) the individual driller 5 supervised or managed. The resulting one or more performance scores 680 for the one or more individual drillers 5 can be used to determine the overall performance score 690 for the rig plan 102. The rig plan 102 or future rig plans 102 can be modified based on the performance scores 680, 690.

### VARIOUS EMBODIMENTS

Embodiment 1. A method for performing a subterranean operation comprising:
controlling, via an individual driller, execution of at least a portion of a digital rig plan, wherein the digital rig plan is an implementation of a digital well plan on a rig;
determining, via a rig controller, a first performance score of the individual driller for controlling the execution of the portion; and
adjusting, via the rig controller, a second performance score of the digital rig plan based on the first performance score of the individual driller, wherein the second performance score indicates performance of the digital rig plan to the digital well plan.

Embodiment 2. The method of embodiment 1, further comprising:
calculating, via one or more processors in a downhole tool, the first performance score and the second performance score; and
reporting the first performance score and the second performance score to surface equipment.

Embodiment 3. The method of embodiment 2, further comprising receiving data from a plurality of data sources at the one or more processors in the downhole tool via a telemetry system.

Embodiment 4. The method of embodiment 1, wherein the portion of the digital rig plan comprises at least one activity of the digital well plan, with the method further comprising:
detecting, via the rig controller, one or more individuals performing the at least one activity;
determining, via the rig controller, a third performance score for the activity, wherein the third performance score is at least based on a level of performance of the one or more individuals performing the activity; and
determining, via the rig controller, the first performance score of the individual driller based on the third performance score.

Embodiment 5. The method of embodiment 4, wherein determining the third performance score for the activity further comprises determining, via the rig controller, a fourth performance score for each of the one or more individuals performing the at least one activity, wherein the fourth performance score is based on a level of performance of a respective one of the one or more individuals performing the activity, and wherein the third performance score is at least partially based on the fourth performance score.

Embodiment 6. The method of embodiment 4, wherein determining the third performance score for the activity further comprises determining, via the rig controller, a fifth performance score for rig equipment performing the at least one activity, wherein the fifth performance score is based on a level of performance of the rig equipment performing the activity, and wherein the third performance score is at least partially based on the fifth performance score.

Embodiment 7. The method of embodiment 4, wherein the third performance score comprises a third historical performance component and a third real-time performance component, and wherein the third historical performance component is stored in a database and retrieved when the rig controller is allocating one or more individuals to one or more portions of the digital rig plan.

Embodiment 8. The method of embodiment 7, wherein the third real-time performance component is updated in real-time as the digital rig plan is executed and the rig controller receives data from various data sources on or off the rig, or downhole.

Embodiment 9. The method of embodiment 1, wherein the first performance score comprises a first historical performance component and a first real-time performance component, and wherein the first historical performance component is stored in a database and retrieved when the rig controller is allocating one or more individual drillers to one or more portions of the digital rig plan.

Embodiment 10. The method of embodiment 9, wherein the first real-time performance component is updated in real-time based on data received at the rig controller from data sources positioned on or off the rig, or downhole.

Embodiment 11. The method of embodiment 1, wherein the individual driller is at a remote location, and wherein determining the first performance score comprises scoring a decision made by the individual driller that impacts execution of the digital rig plan.

Embodiment 12. The method of embodiment 11, wherein the decision is at least one of a directional steering decision, a geological steering decision, a well control decision, a mud weight decision, a hydrostatic pressure decision, or combinations thereof.

Embodiment 13. The method of embodiment 11, wherein the decision impacts performance of at least one task of the digital rig plan, and wherein the first performance score is calculated to include the performance of the at least one task.

Embodiment 14. The method of embodiment 10, wherein the data sources collect information on rig operations and provide the information to the rig controller or remote users, and wherein the information comprises:
imagery data;
sensor data;
identification of an individual;
environmental conditions;
rig equipment operating conditions;
health of the rig equipment and one or more individuals;
activity of the digital well plan or digital rig plan;
weight on bit (WOB);
rate of penetration (ROP);
revolutions per minute (RPM) of a tubular string;
RPM of a drill bit;
downhole pressure;
downhole temperature;
surface temperature;
position of a valve whether opened, closed, or partially opened;
level of fluid in a tank;
amount of drilling fluid in an active system;
properties of a surrounding subterranean formation;
depth of wellbore;
length of the tubular string;
rheology of operational fluids; and
combinations thereof.

Embodiment 15. The method of embodiment 1, wherein the second performance score comprises a second historical performance component and a second real-time performance component, wherein the second historical performance component is stored in a database and indicates a level of performance of the rig for a previous digital rig plan.

Embodiment 16. The method of embodiment 15, wherein the second real-time performance component is updated in real-time based on data received at the rig controller from data sources positioned on or off the rig, or downhole.

Embodiment 17. The method of embodiment 1, wherein controlling the execution of the portion of the digital rig plan comprises:
selecting, via the individual driller, one or more recipes to manage the execution of the portion of the digital rig plan; and
adjusting the first performance score based on the execution of the portion of the digital rig plan based on the selected one or more recipes.

Embodiment 18. The method of embodiment 17, further comprising:
determining a sixth performance score for each of the one or more recipes, wherein the sixth performance score indicates a level of performance of the portion of the digital rig plan to the digital well plan based on a respective one of the one or more recipes.

Embodiment 19. The method of embodiment 1, further comprising:
retrieving the first performance score from a database for each one of one or more individual drillers; and
allocating each one of the one or more individual drillers when converting the digital well plan to the digital rig plan based on respective first performance scores.

Embodiment 20. The method of embodiment 19, further comprising:
selecting recipes for rig equipment based on the one or more individual drillers, wherein the recipes comprise operational parameters for setting up, running, or controlling the rig equipment.

Embodiment 21. The method of embodiment 1, further comprising:
receiving a deviation from the digital rig plan;
determining a new sequence of rig tasks to perform the deviation from the digital rig plan, wherein the new sequence of rig tasks comprises a subset of available rig tasks;
inserting the new sequence of rig tasks into the digital rig plan; and
allocating one or more individual drillers to the rig tasks in the new sequence of rig tasks based on the respective first performance score for each of the one or more individual drillers.

Embodiment 22. The method of embodiment 21, further comprising:
selecting recipes for rig equipment for the new sequence of rig tasks based on the one or more individual drillers, wherein the recipes comprise operational parameters for setting up, running, or controlling the rig equipment.

Embodiment 23. The method of embodiment 21, further comprising:
selecting one or more individuals for performing the new sequence of rig tasks based on a fifth performance score for each one of the one or more individuals.

Embodiment 24. A system for performing a subterranean operation comprising a computer configured to perform any methods of the current disclosure.

While the present disclosure may be susceptible to various modifications and alternative forms, specific embodiments have been shown by way of example in the drawings and tables and have been described in detail herein. However, it should be understood that the embodiments are not intended to be limited to the particular forms disclosed. Rather, the disclosure is to cover all modifications, equivalents, and alternatives falling within the spirit and scope of the disclosure as defined by the following appended claims. Further, although individual embodiments are discussed herein, the disclosure is intended to cover all combinations of these embodiments.

1. A method for performing a subterranean operation comprising:
controlling, via an individual driller, execution of at least a portion of a digital rig plan, wherein the digital rig plan is an implementation of a digital well plan on a rig;
determining, via a rig controller, a first performance score of the individual driller for controlling the execution of the portion; and
adjusting, via the rig controller, a second performance score of the digital rig plan based on the first performance score of the individual driller, wherein the second performance score indicates performance of the digital rig plan to the digital well plan.

2. The method of claim 1, further comprising:
calculating, via one or more processors in a downhole tool, the first performance score and the second performance score; and
reporting the first performance score and the second performance score to surface equipment.

3. The method of claim 2, further comprising receiving data from a plurality of data sources at the one or more processors in the downhole tool via a telemetry system.

4. The method of claim 1, wherein the portion of the digital rig plan comprises at least one activity of the digital well plan, with the method further comprising:
detecting, via the rig controller, one or more individuals performing the at least one activity;
determining, via the rig controller, a third performance score for the activity, wherein the third performance score is at least based on a level of performance of the one or more individuals performing the activity; and
determining, via the rig controller, the first performance score of the individual driller based on the third performance score.

5. The method of claim 4, wherein determining the third performance score for the activity further comprises determining, via the rig controller, a fourth performance score for each of the one or more individuals performing the at least one activity, wherein the fourth performance score is based on a level of performance of a respective one of the one or more individuals performing the activity, and wherein the third performance score is at least partially based on the fourth performance score.

6. The method of claim 4, wherein determining the third performance score for the activity further comprises determining, via the rig controller, a fifth performance score for rig equipment performing the at least one activity, wherein the fifth performance score is based on a level of performance of the rig equipment performing the activity, and wherein the third performance score is at least partially based on the fifth performance score.

7. The method of claim 4, wherein the third performance score comprises a third historical performance component and a third real-time performance component, and wherein the third historical performance component is stored in a database and retrieved when the rig controller is allocating one or more individuals to one or more portions of the digital rig plan.

8. The method of claim 7, wherein the third real-time performance component is updated in real-time as the digital rig plan is executed and the rig controller receives data from various data sources on or off the rig, or downhole.

9. The method of claim 1, wherein the first performance score comprises a first historical performance component and a first real-time performance component, and wherein the first historical performance component is stored in a database and retrieved when the rig controller is allocating one or more individual drillers to one or more portions of the digital rig plan.

10. The method of claim 9, wherein the first real-time performance component is updated in real-time based on data received at the rig controller from data sources positioned on or off the rig, or downhole.

11. The method of claim 1, wherein the individual driller is at a remote location, and wherein determining the first performance score comprises scoring a decision made by the individual driller that impacts execution of the digital rig plan.

12. The method of claim 11, wherein the decision impacts performance of at least one task of the digital rig plan, and wherein the first performance score is calculated to include a performance of the at least one task.

13. The method of claim 1, wherein the second performance score comprises a second historical performance component and a second real-time performance component, wherein the second historical performance component is stored in a database and indicates a level of performance of the rig for a previous digital rig plan.

14. The method of claim 1, wherein controlling the execution of the portion of the digital rig plan comprises:
selecting, via the individual driller, one or more recipes to manage the execution of the portion of the digital rig plan; and
adjusting the first performance score based on the execution of the portion of the digital rig plan based on the selected one or more recipes.

15. The method of claim 14, further comprising:
determining a sixth performance score for each of the one or more recipes, wherein the sixth performance score indicates a level of performance of the portion of the digital rig plan to the digital well plan based on a respective one of the one or more recipes.

16. The method of claim 1, further comprising:
retrieving the first performance score from a database for each one of one or more individual drillers; and
allocating each one of the one or more individual drillers when converting the digital well plan to the digital rig plan based on respective first performance scores.

17. The method of claim 16, further comprising:
selecting recipes for rig equipment based on the one or more individual drillers, wherein the recipes comprise operational parameters for setting up, running, or controlling the rig equipment.

18. The method of claim 1, further comprising:
receiving a deviation from the digital rig plan;
determining a new sequence of rig tasks to perform the deviation from the digital rig plan, wherein the new sequence of rig tasks comprises a subset of available rig tasks;
inserting the new sequence of rig tasks into the digital rig plan; and
allocating one or more individual drillers to the rig tasks in the new sequence of rig tasks based on the respective first performance score for each of the one or more individual drillers.

19. The method of claim 18, further comprising:
selecting recipes for rig equipment for the new sequence of rig tasks based on the one or more individual drillers, wherein the recipes comprise operational parameters for setting up, running, or controlling the rig equipment.

20. The method of claim 18, further comprising:
selecting one or more individuals for performing the new sequence of rig tasks based on a fifth performance score for each one of the one or more individuals.
